(19) United States
(12) Patent Application Publication
(10) Pub. No.: US 2008/0151099 A1
(43) Pub. Date: Jun. 26, 2008

(54) PORTABLE ELECTRONIC DEVICE

(75) Inventors: Kuo-Kun LIN, TAIPEI (TW); Chu-Chia Tsai, Taipei (TW); Wei-Hong Liu, Taipei (TW); Wen-Chin Wu, Taipei (TW); Chia-Hsien Lee, Taipei (TW); Deng-Zhou Zheng, Taipei (TW); An-Chung Hsieh, Taipei (TW); Yi-Chun Chen, Taipei (TW)

Correspondence Address: QUINTERO LAW OFFICE, PC, 2210 MAIN STREET, SUITE 200, SANTA MONICA, CA, 90405, US

(73) Assignee: WISTRON CORP., TAIPEI HSIEN (TW)

(21) Appl. No.: 11/928,963

(22) Filed: Oct. 30, 2007

(30) Foreign Application Priority Data
Dec. 25, 2006 (TW) TW95222748

(51) Int. Cl. H04N 5/225

(52) U.S. Cl. 348/376; 348/E05.024

(57) ABSTRACT

A portable electronic device comprises a body, a cover, an input interface, a display, an image capture device and a fixing arm. The cover is rotatably connected to the body. The input interface is disposed on the body. The display is disposed on the cover. The image capture device is disposed on the cover. When an image medium is fixed on the fixing arm, the image capture device captures image data from the image medium.

### BACKGROUND OF THE INVENTION

1. Field of the Invention

The invention relates to a portable electronic device, and more particularly to a portable electronic device capturing image data from image media.

2. Description of the Related Art

FIG. 1 shows a conventional image capture device 1 comprising an image capture device 10 and a holder 20. The image capture device 10 is connected to the holder 20. An image medium 30 (for example, business card) is fixed on the holder 20, and the image capture device 10 captures image data therefrom.

Conventionally, the image data caught from the image medium 30 is stored in the image capture device 10, or transmitted to a notebook or other portable electronic devices via transmission line. However, the conventional image capture device 1 is large and inconvenient to transport. Additionally, the cost of conventional image capture device 1 increases with data storage and transmission functions.

### BRIEF SUMMARY OF THE INVENTION

A detailed description is given in the following embodiments with reference to the accompanying drawings.

The embodiment relates to a portable electronic device comprising a body, a cover, an input interface, a display, an image capture device and a fixing arm. The cover is rotatably connected to the body. The input interface is disposed on the body. The display is disposed on the cover. The image capture device is disposed on the cover. When an image medium is fixed on the fixing arm, the image capture device captures image data from the image medium.

The image capture process (for example, business card copy process) is thus simplified, and easily performed. Additionally, the image capture device of the invention is directly incorporated on the portable electronic device (notebook), and cost of image capture is therefore reduced.

### BRIEF DESCRIPTION OF THE DRAWINGS

The invention can be more fully understood by reading the subsequent detailed description and examples with references made to the accompanying drawings, wherein:

FIG. 1 shows a conventional image capture device;

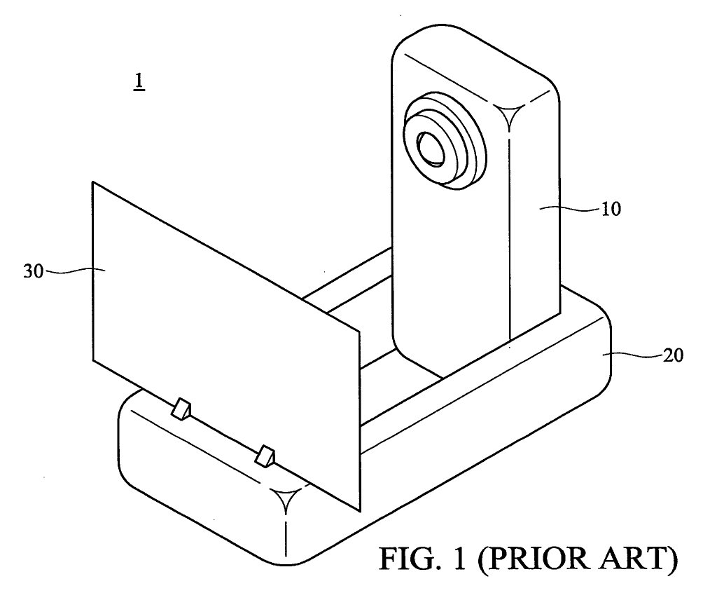

FIG. 2a shows a portable electronic device of a first embodiment;

FIG. 2b shows the portable electronic device of the first embodiment capturing image data from an image medium;

FIG. 2c shows a detailed structure of a fixing arm of the first embodiment;

FIG. 3a shows a portable electronic device of a second embodiment capturing image data from an image medium;

FIG. 3b shows a fixing arm of the second embodiment in a second position; and

FIG. 3c shows the fixing arm of the second embodiment in a first position.

### DETAILED DESCRIPTION OF THE INVENTION

The following description is made for the purpose of illustrating the general principles of the invention and should not be taken in a limiting sense. The scope of the invention is determined by reference to the appended claims.

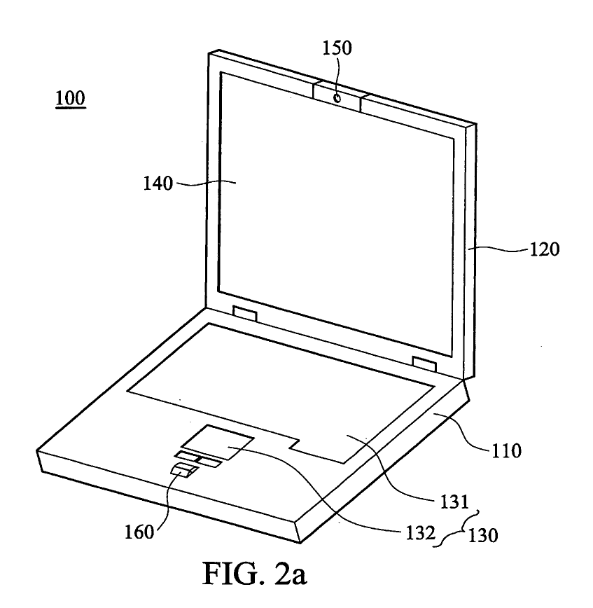

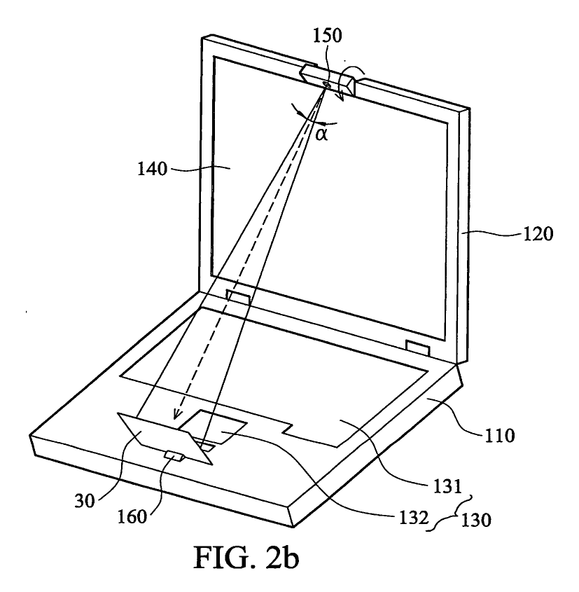

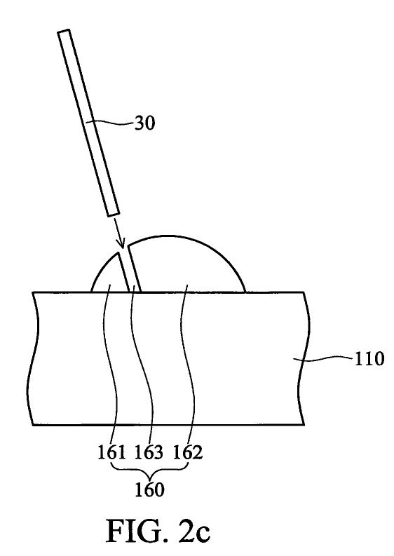

FIG. 2a shows a portable electronic device (notebook) 100 of a first embodiment of the invention comprising a body 110, a cover 120, an input interface 130, a display 140, an image capture device 150 and a fixing arm 160. The cover 120 is rotatably connected to the body 110. The input interface 130 is disposed on the body 110 including a keyboard 131 and a cursor control unit 132. The display 140 is disposed on the cover 120. The image capture device 150 is disposed on the cover 120. The fixing arm 160 is disposed on the body 110. The cursor control unit 132 is located between the fixing arm 160 and the keyboard 131.

With reference to FIG. 2b, the image capture device 150 is rotatably disposed on the cover 120. When the image capture device 150 captures image data, an image medium 30 (for example, business card) is fixed on the fixing arm 160, and the image capture device 150 pivots corresponding to the image medium 30 to capture image data therefrom.

In the first embodiment, a view angle α of the image capture device 150 is controlled manually or automatically by software to precisely capture image data from the image medium 30. In the first embodiment, the view angle α is about 60° to 65°.

FIG. 2c shows detailed structure of the fixing arm 160 comprising a first section 161 and a second section 162 for holding the image medium 30. A slot 163 is formed between the first section 161 and the second section 162. The image medium 30 is inserted in the slot 163. The first section 161 and the second section 162 are sector shaped structures.

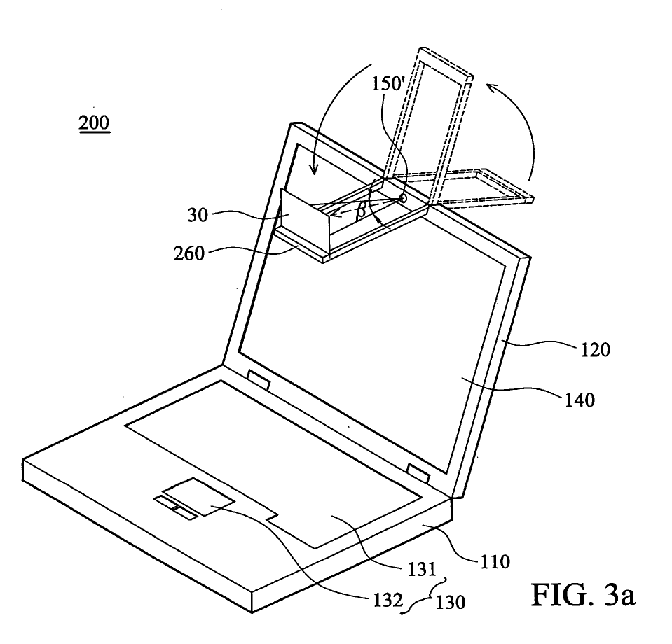

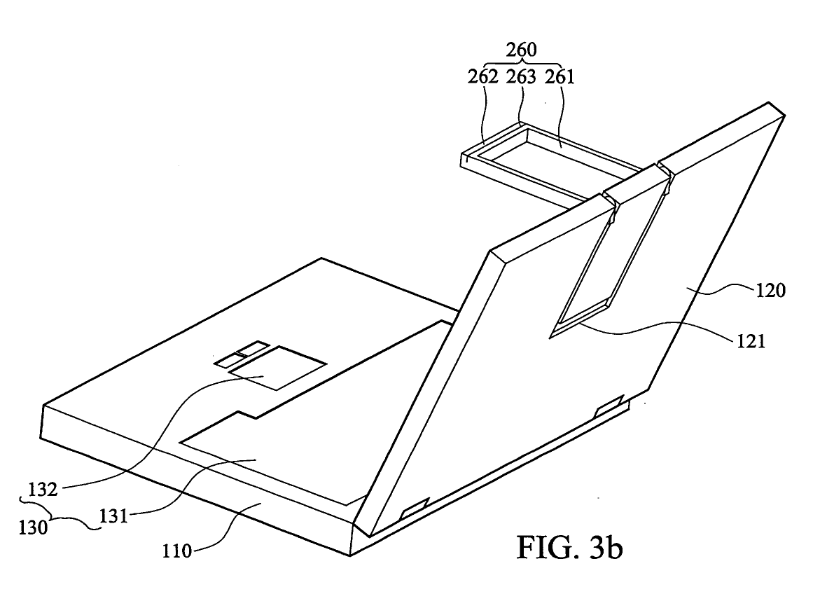

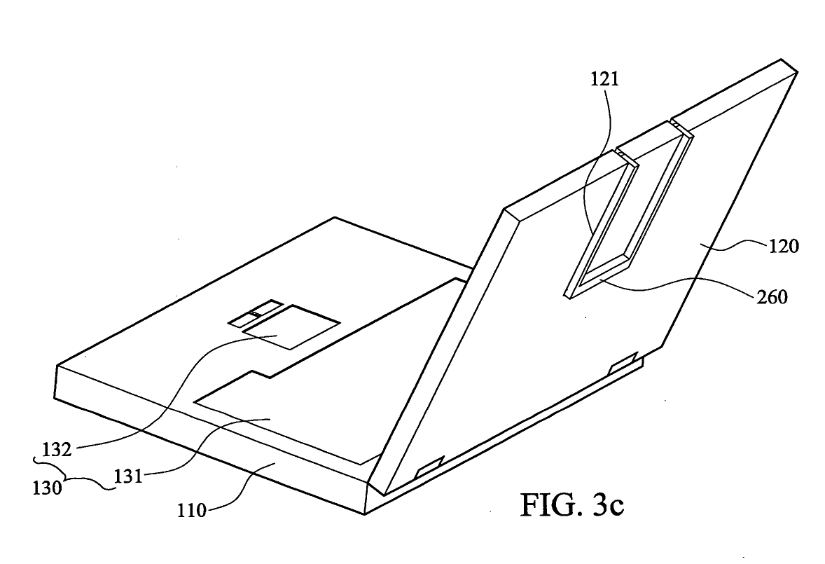

FIG. 3a shows a portable electronic device (notebook) 200 of a second embodiment of the invention, characteristic in comprising a fixing arm 260 rotatably connected on the cover 120.

With reference to FIG. 3b, the fixing arm 260 is a U-shaped structure comprising a supporting frame 261 and a fixer 262. The supporting frame 261 is rotatably connected to the cover 120. The fixer 262 is connected to the supporting frame 261. The fixer 262 comprises a slot 263. The image medium 30 is inserted in the slot 263 to be fixed on the fixer 262. The cover 120 comprises a receiving portion 121. With reference to FIGS. 3a, 3b and 3c, when the fixing arm 260 is in a first position, the fixing arm 260 is received in the receiving portion 121 (FIG. 3c). When the fixing arm 260 is in a second position, the image medium 30 is fixed on the fixing arm 260, and the image capture device 150′ captures image data therefrom (FIG. 3a).

With reference to FIG. 3a, in the second embodiment, the image capture device 150′ is fixed on the cover 120. A view angle β of the image capture device 150′ is controlled manually or automatically by software to precisely capture image data from the image medium 30. In the second embodiment, the view angle β is about 75° to 80°.

The portable electronic device requires no externally connected image capture device. The image capture process (for example, business card copy process) is thus simplified, and easily performed. Additionally, the image capture device of the invention is directly incorporated on the portable electronic device (notebook), and cost of image capture is therefore reduced.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A portable electronic device capable of capturing images from an image medium, comprising:
a body;
a cover, rotatably connected to the body;
an input interface, disposed on the body;
a display, disposed on the cover;
an image capture device, disposed on the cover; and
a fixing arm disposed on the body and having a slot for receiving the image medium, wherein when the image medium is inserted in the slot of the fixing arm, the image medium is in a view region of the image capture device capable of capturing image data from the image medium.

2. The portable electronic device as claimed in claim 1, wherein the image capture device is rotatably disposed on the cover.

3. The portable electronic device as claimed in claim 1, wherein the input interface comprises a keyboard and a cursor control unit, and the cursor control unit is located between the fixing arm and the keyboard.

4. The portable electronic device as claimed in claim 1, wherein the fixing arm comprises a first section and a second section, the slot is formed between the first section for receiving the image medium.

5. The portable electronic device as claimed in claim 4, wherein the first section comprises a sector shaped structure.

6. The portable electronic device as claimed in claim 4, wherein the second section comprises a sector shaped structure.

7. A portable electronic device capable of capturing images from an image medium, comprising:
a body;
a cover, rotatably connected to the body;
an input interface, disposed on the body;
a display, disposed on the cover;
an image capture device, disposed on the cover; and
a fixing arm disposed on the cover for receiving the image medium, wherein when the image medium is inserted in the slot of the fixing arm, the image medium is in a view region of the image capture device capable of capturing image data from the image medium.

8. The portable electronic device as claimed in claim 7, wherein the fixing arm is rotatably connected to the cover.

9. The portable electronic device as claimed in claim 8, wherein the fixing arm comprises a supporting frame and a fixer, the supporting frame is rotatably connected to cover, the fixer is connected to the supporting frame for fixing the image medium.

10. The portable electronic device as claimed in claim 8, wherein the fixer forms a slot for receiving the image medium.

11. The portable electronic device as claimed in claim 8, wherein the cover comprises a receiving portion, the fixing arm is rotatable between a first position and a second position, the fixing arm is received in the receiving portion when the fixing arm is in the first position.

12. The portable electronic device as claimed in claim 8, wherein the fixing arm is a U-shaped structure.
